(19) United States
(12) Patent Application Publication
(10) Pub. No.: US 2008/0002011 A1
(43) Pub. Date: Jan. 3, 2008

(54) Method of manufacturing corrugated cardboard product

(76) Inventors: Kozo Mizutani, Kasugai-shi (JP); Hideyuki Isowa, Kasugai-shi (JP)

Correspondence Address: BRINKS HOFER GILSON & LIONE, P.O. BOX 10395, CHICAGO, IL, 60610, US

(21) Appl. No.: 11/787,628

(22) Filed: Apr. 17, 2007

Related U.S. Application Data
(63) Continuation-in-part of application No. 11/409,551, filed on Apr. 20, 2006.

(30) Foreign Application Priority Data
Jul. 7, 2006 (JP) 2006-187947

(51) Int. Cl. B41J 2/01

(52) U.S. Cl. 347/104

(57) ABSTRACT

A method of manufacturing a printed cardboard product is described. The method includes the steps of manufacturing a single- or double-faced cardboard sheet, and printing a first face of the cardboard sheet not having press marks in a rotary press. An image may be printed on a second face having press marks using an ink jet printer. The rotary printing process may use a fixed image for a production lot, and smaller production lots therefrom printed using the ink jet printer, where the image printed by the ink jet printer may differ from one of the smaller lots to another of the smaller lots. In another aspect, single-faced corrugated cardboard sheets may be produced having an undulating corrugation pattern, and the liner sheet printed using an ink jet process. The printed sheet is formed into a box, where the printed sheet forms the interior of the box.

This application is a continuation-in-part of U.S. patent application Ser. No. 11/409,551, filed on Apr. 20, 2006, which claims priority to Japanese patent application 2005-175369 filed on Jun. 15, 2005, and claims the benefit of priority under 35 U.S.C. 119 (a)-(d) to Japanese patent application 2006-187947, filed on Jul. 7, 2006, each of which are incorporated herein by reference.

### TECHNICAL FIELD

The present application is directed to a method for manufacturing corrugated cardboard products, and in particular a method for printing liners of corrugated cardboard sheets with press marks resulting from the production of single-faced corrugated cardboard sheets.

### BACKGROUND

Conventionally, double-faced corrugated cardboard products have been manufactured using single-faced corrugated cardboard sheets which comprise a first liner or liner sheet and a corrugated core or core sheet, and a second liner or liner sheet. Multi-layered corrugated sheets or assemblies comprise two or more single-faced corrugated cardboard sheets or assemblies and/or two or more liners with a second liner sheet applied to the exposed corrugated core or core sheet thereof. The resulting double-faced or multi-layered corrugated cardboard sheets are then printed, scored or creased, slotted or die-cut before folding and assembling into the corrugated cardboard product such as a corrugated cardboard box.

The conventional process for manufacturing corrugated cardboard products comprises first producing a single-faced corrugated cardboard sheet in so-called single facer as illustrated in FIG. 14. The single facer generally comprises a pair of corrugating rolls 400a, 400b, a press roll 410 having a smooth outer surface, a gluing mechanism 440 including an applicator roll 420 and a doctor roll 430. The tension of the core web to be formed into a core sheet is adjusted by a dancing roller 460 disposed between a pair of feed rollers 450. The core web is passed between the pair of corrugating rollers 400a, 400b under a predetermined nip pressure. The interior of the pair of corrugating rollers 400a, 400b and that of the press roller 410 are heated. The corrugations are imparted to the core web under the combined action of pressure and heat to form the core sheet. Glue is then applied to the crests, peaks or top portions of the corrugations of the core sheet by means of the gluing mechanism 440. The glued corrugated core sheet and the first liner sheet are separately fed. The first core sheet is preheated by the pre-heating rolls 470 located upstream of press roll 410. The first core sheet and the corrugated core sheet are pressed together under the predetermined nip pressure exerted between a downstream portion of corrugating roller 400b and the press roll 410 to form a single-faced corrugated cardboard sheet which is then fed to the following stage by a guide roller 480 and pair of feed belts 490.

Then, double-faced corrugated cardboard sheets are produced from the single-faced corrugated cardboard sheets in a so-called double facer. As shown in FIG. 15, the double facer generally includes an upstream heating section 500 which heats the glued single-faced corrugated cardboard sheets and the first liner sheet to be adhered to each other. A heat dissipating section 510 stabilizes the glued portions while the single-faced corrugated cardboard sheets and the second liner sheet are being transferred. A conveyor belt 520 extends between the heating section 500 and the heat dissipating section 510. The heating section 500 comprises heating platens 530 aligned in the sheet transfer direction, and opposed pressure rolls 540 which apply pressure to the corrugated cardboard sheets through the conveyor belt 520 to increase the transfer of heat. The heat dissipating section 510 comprises a lower belt facing the conveyor belt 520. In the above-described double facer, the glued singled-faced corrugated cardboard sheets and liner sheet are transferred by the conveyor belt 520 which is driven by driving roll 560 and pass between the conveyor belt 520 and the heat platens 530 under a predetermined nip pressure. The glued portions are dried by heat supplied by the heating platens 530, thereby assembling respective single-faced corrugated sheets and second liner sheets into the double-faced corrugated cardboard sheets as they are being transferred by the conveyor belt 520 and a lower belt 550 driven by the driving roller 570 in the heat dissipating section 510.

The nip pressure applied between the first liner sheet and the core sheet in a single facer is relatively high, for example about 40 kg/cm, while that the nip pressure applied between the single-faced corrugated sheet and the second liner in the double facer is relatively low, for example about 5 kg/cm. Indeed in the course of securing the single-faced corrugated sheet to the second liner the corrugations or flutes in the corrugated sheet are already in a predetermined relative positions whereas in the course of securing the core sheet to the liner sheet the corrugations have to be maintained in relative position as they are not yet secured to the first liner sheet.

Owing to the relatively high nip pressure being exerted during the securement or bonding of the core sheet to the first liner sheet, linear marks are formed in the liner sheet as schematically shown in FIG. 16(a). These linear marks are spaced apart from each other by the distance corresponding to the pitch or spacing between the adjacent crests or peaks of the corrugating roll. These linear marks, or so-called press marks, which extend in the direction parallel to the direction of the corrugations or flutes of the corrugated core sheet C are generated on the surface S1 of the double-faced corrugated cardboard sheets, that is the outer surface of the first liner sheet, but no press marks are generated on the other surface S2, that is the outer surface of the second liner sheet which is subsequently secured to the exposed corrugations of the single-faced corrugated sheet.

Multi-layered corrugated cardboard sheets are manufactured by stacking and securing to one another a plurality of single-face corrugated cardboard sheets and liners, and then securing to the sole exposed core sheet a top or second liner sheet to complete the assembly in the same manner as a double-faced corrugated cardboard sheet.

The double-faced or multi-layered corrugated sheets or assemblies are then typically printed in a so-called rotary press or printing unit. Such a printing unit comprises a printing cylinder with a printing plate on its peripheral surface, a pressure roll disposed opposite the printing cylinder, an ink transfer roller which transfers ink to the printing die or plate. The corrugated sheet to be printed passes between the printing cylinder and the pressure roller to transfer the ink from the printing die or plate to the surface of the sheet at the nip therebetween while the sheet is being displaced in the direction of rotation of the printing cylinder. For multiple-color printing on the surface of the liner of the corrugated cardboard sheets, a plurality of such printing units are disposed in series along the feed direction and a predetermined color is printed at each printing unit to obtain the desired multiple-color image once the corrugated cardboard sheet has passed through all of the printing units.

Thereafter the printed corrugated sheet is scored or creased and slotted, or die-cut and the corrugated cardboard sheet is assembled with the printed surface is on outside or exterior side, thereby completing the corrugated cardboard box or other product.

Printing of the double-faced or the multi-layered corrugated cardboard sheets has limitations and drawbacks.

One of the surfaces of the corrugated sheet will have press marks and the other surface will have none, whether it is double-faced or a multi-layered corrugated cardboard sheet. Corrugated cardboard sheets are printed on the surface of the second liner sheet, the one without press marks, mainly for esthetic reasons. For instance, in the case of the corrugated cardboard box, a bar code indicating contents, logo, or any other image including text is printed on the surface which will be on the outside. Thus the surface with the press marks which will define the interior surface is normally not printed.

Nowadays, there are numerous applications corrugated cardboard sheets not only for the corrugated cardboard boxes for storing and shipping merchandise but also for bookshelves, furniture, gift boxes, and so on. Since a design of such corrugated cardboard products draws much attention, a clear and esthetically pleasing printed image is required. For such products and even for corrugated cardboard boxes there is a demand for a clear and esthetically pleasing printed image also on an inner surface of the corrugated cardboard product.

In the case of the gift box for a birthday, there is a demand for multiple-color printing of a congratulatory message, pictures or photographs and other images on an underside of a cover of the box corresponding to an inside surface of the corrugated cardboard product is in demand.

But conventional printing in a rotary press on the surface of the corrugated cardboard sheet with press marks in a rotary press poses technical problems.

First, when printing on the surface of the corrugated cardboard sheets with the press marks, the press marks become even more conspicuous, and therefore the resulting printed corrugated cardboard sheet becomes esthetically unattractive.

Second, the expected runs or lots for such articles are small or short but rotary press printing is suitable for high volume runs or jobs with a ‘constant’ or preset printed image, but is unsuitable for printing jobs on demand.

Third, in a case where multiple-color printing is required for the surface with the press marks, a printing unit for single color on the second side of the sheet carried out in series on-line, printing efficiency has to be maintained while problems of color registration increase each time the sheets are passed through a printing unit to print the sheets on one side and then the other. If one of the surfaces of the corrugated cardboard sheets is printed in a series of printing units, the printing dies or plates have to be replaced and/or cleaned and inks changed before the other surface of the corrugated cardboard sheet may be is printed by the same series of the printing units, which may eliminate problems of color registration but compromise printing efficiency.

In addition, where the number of printing units corresponds to the greatest possible number of desired colors, this relatively large number of printing units aligned for printing in series, has to be traversed by the sheets even though a lesser number of printing units are to be used for a given job. This aggravates registration problems between the colors printed in the respective printing units since deviations in sheet position result from each printing unit whether it is or is not in use.

In view of the foregoing it is abundantly clear that conventional rotary printing presses are unsuitable for the corrugated cardboard products such as gift box where the printed features such colors, patterns, shapes and other images, and/or texts draw much attention.

### SUMMARY

The method utilizes printing configurations of rotary press printing and ink jet printing, the former being used for large volume printing jobs with a constant or preset print image, while the latter being used for small volume or custom printing jobs with a variety of print images.

According to one aspect, there is provided a method for producing a corrugated cardboard product made from single-faced corrugated cardboard sheets having press marks corresponding to zones where the crests of the corrugated core sheet are glued or adhered to the first liner of the single-face corrugated sheets, the surface of the first liner being ink jet printed whereby the press marks are not made more conspicuous through printing.

More specifically unlike the conventional rotary press printing where there is physical contact been the printing dies or plates and the corrugated sheet, ink jet printing enables the sheet to be printed in a single pass without physical contact between the first liner and the printing unit which in the case of ink jet printing involves the impact of ink jet droplets with the surface to be printed.

Ink jet printing of single-faced corrugated cardboard sheet admits of the production of printed products having unique designs such as wavy patterned corrugated core sheets which can be used to define the outer surface of the product, the inner surface being defined by the ink jet printed first liner.

According to another aspect, a constant or preset printed image is produced on one side of a corrugated cardboard sheet by rotary press printing in large volumes, and the other side of the corrugated cardboard sheet is ink jet printed in small volumes or on demand with a virtually unlimited variety of possible images.

This eliminates a need for preparing printing dies or plates for such a large variety of possible images which would be the case if the large variety of images where printed in a conventional rotary press. Ink jet printing also admits of adding, modifying, or changing the printing position as the occasion demands, since only modified digital data is required to produce the desired printed image.

Also with ink jet printing, testing to ascertain colors, color registration and print position by preparing proofs necessary for the conventional rotary press printing of corrugated cardboard sheets may be eliminated and so can maintenance operations such as cleaning the rollers and the ink tubes after a press run and before another press run.

In addition, for multiple-color printing, it is not necessary to provide printing units for each printing color as is the case with conventional rotary press printing, all colors can be produced by ink jet printing in a single pass of a single ink jet printing unit thereby eliminating problems of color registration which are unavoidable due to differences in the printing position in a plurality of the rotary press printing units even when all units are not involved in the production of a given printed image.

The high overall printing efficiency can be attained because constant or preset print images can be produced on large runs of corrugated cardboard sheets by rotary press printing, while a large variety of images can be produced on demand and off-line by ink jet printing in small runs on the pre-printed corrugated cardboard sheets.

Further, the high throughput rate rotary press printing can being combined in a single pass with creasing or scoring, slotting or die-cutting and stacking steps along with the removal of paper dust and shreds, produced in the course of slotting or die-cutting, from the sheets before the subsequent ink jet printing operation.

### BRIEF DESCRIPTION OF THE DRAWINGS

FIG. 1 is a flowchart for a first embodiment;

FIG. 2 is a side view of rotary press printing units of the first embodiment;

FIG. 3 is a plan view of the ink jet printing units of the first embodiment;

FIG. 4 is a side view of the ink jet printing units of the first embodiment;

FIG. 5 is a view of the control system of the ink jet printing units of the first embodiment;

FIG. 6 is a plan view of the ink jet nozzles of the ink jet printing units of the first embodiment;

FIG. 7 is a plan view of the suction box of the first embodiment;

FIG. 8 is a view showing the sheet being printed in the first embodiment;

FIG. 9 is a perspective view showing the completed corrugated product according to the first embodiment;

FIG. 10 is a perspective view showing the rollers of a second embodiment;

FIG. 11 is a plan view showing the teeth of the corrugating rolls of the second embodiment;

FIG. 12 is a partial perspective view showing the wavy patterned corrugated sheet of the second embodiment;

FIG. 13 is a perspective view showing the wavy patterned corrugated product in the second embodiment;

FIG. 14 is a side view showing a conventional single facer;

FIG. 15 is a side view showing a conventional double facer; and

FIG. 16 is a perspective view showing the resulting double-faced sheet.

### DETAILED DESCRIPTION

Exemplary embodiments may be better understood with reference to the drawings, but these examples are not intended to be of a limiting nature. Like numbered elements in the same or different drawings perform equivalent functions. When a specific feature, structure, or characteristic is described in connection with an example, it will be understood that one skilled in the art may effect such feature, structure, or characteristic in connection with other examples, whether or not explicitly stated herein.

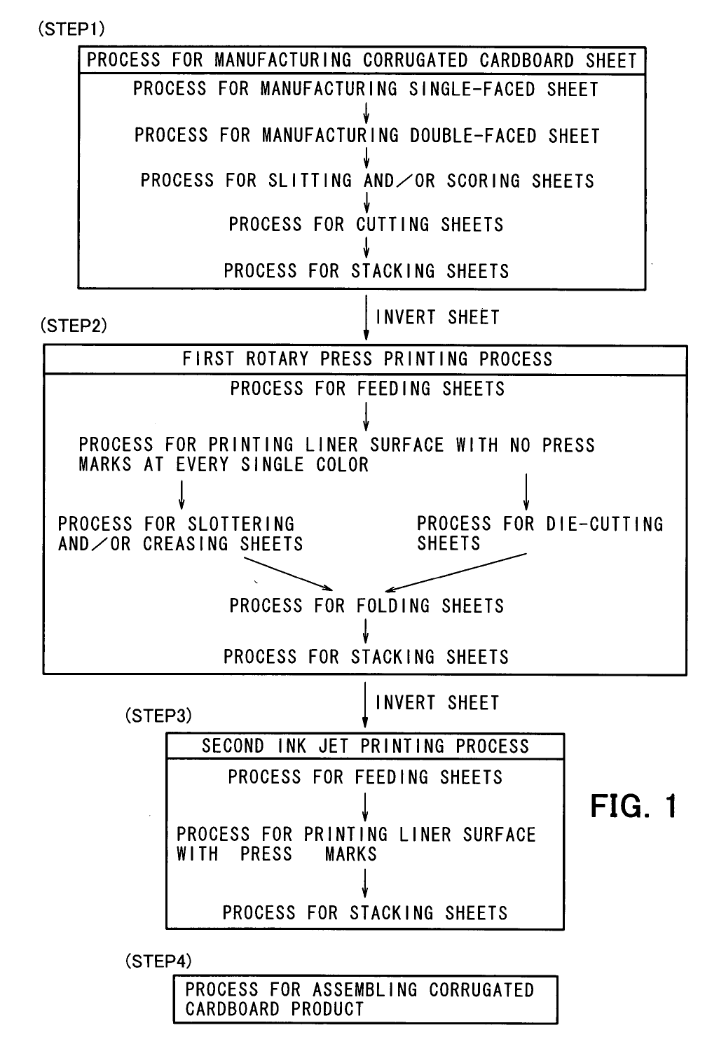

As shown in the flow chart of FIG. 1, the method of producing printed corrugated cardboard sheet products according to a first embodiment comprises the main steps of: (1) making corrugated cardboard sheets; (2) printing the second liner of the corrugated sheets which is devoid of press marks; (3) printing the first liner which has press marks; and (4) assembling the printed corrugated cardboard sheets into printed cardboard sheet products. The steps 1 to 4 may be carried out off-line.

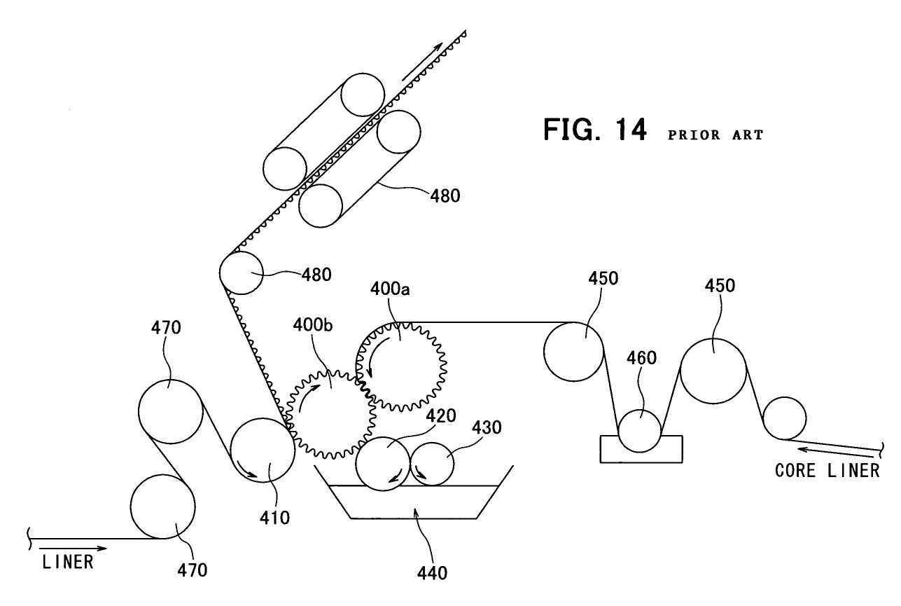

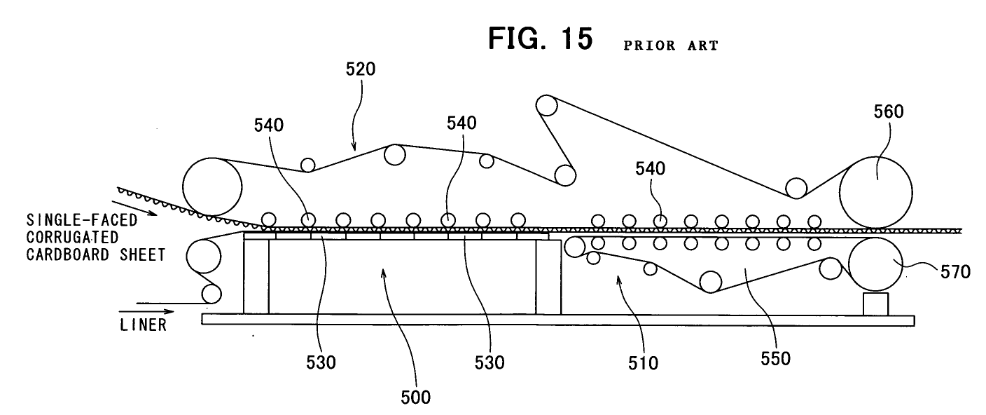

Step 1 of making the corrugated cardboard sheets may be conventional such as illustrated in FIGS. 14 and 15. The making or manufacturing of corrugated cardboard sheets preferably comprises (i) making single-faced corrugated cardboard sheets in a conventional single facer, (ii) then making double-faced corrugated cardboard sheets in a conventional double-facer, (iii) scoring or creasing and slotting, or die-cutting the double-face corrugated cardboard sheets and (iv) then stacking resulting corrugated cardboard sheets.

The basic corrugated cardboard sheet material for the corrugated cardboard used for making the corrugated sheet product is fabricated in a single-facer which is followed by fabrication in a double-facer. Specifically, single-faced corrugated cardboard sheet is made from a corrugated core sheet by corrugating a plain or flat sheet and then gluing or adhering the crests or peaks, also called top portions, of the corrugations on one side of the core sheet to the first liner sheet. The single-faced corrugated sheet may be transformed into a double-faced corrugated cardboard sheet in a double-facer by adhering or gluing the crests or peaks of the exposed side of the corrugated core sheet to the second liner sheet.

Where multi-layered corrugated cardboard sheets are desired, two or more corrugated core sheets and/or single-faced corrugated cardboard sheets and/or liners are adhered or glued to each other to form a multi-layered subassembly, and a final or ‘second’ liner sheet is adhered or glued to an exposed corrugated core surface of the subassembly.

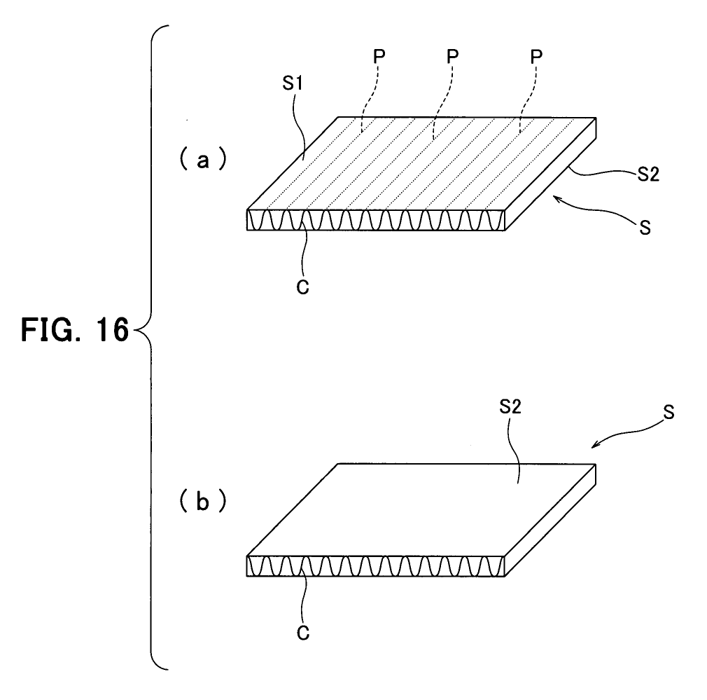

As discussed above, regardless of whether the corrugated cardboard sheet is a single-faced sheet, a double-faced corrugated cardboard sheet or a multi-layered corrugated cardboard sheet or assembly, the first liner sheet has press marks. As shown in FIG. 16, the first liner sheet of the double-faced corrugated cardboard sheet surface which faces upwards (a) has press marks and the second liner sheet facing downwards (b) has no press marks.

Then, the corrugated cardboard sheet is creased or scored and slotted in a so-called slotter-scorer where it is cut in a direction perpendicular to the sheet feeding direction and creased, and thereafter it is cut to a predetermined length with a rotary cutter and the resulting scored or creased and slotted cut sheets are stacked on one another in a stacker.

The description which follows concerns printing steps for double-faced or multi-layered corrugated cardboard sheet.

The first printing step is carried out in a so-called rotary printing press. This first printing step, as shown in FIG. 1, preferably comprises the sub-steps of (i) feeding corrugated cardboard sheets, (ii) printing the second liner sheet (devoid of press marks) in one or more printing units of a rotary printing press depending on the number of colors to be printed, (ii) creasing or scoring and slotting the corrugated cardboard sheets if they were not previously creased or scored and slotted, or alternatively die-cutting corrugated cardboard sheets instead of creasing or scoring and slotting them, (iii) folding the corrugated cardboard sheets in a folder-gluer, and (iv) stacking resulting printed corrugated cardboard sheets on one another.

At the feeding unit, the corrugated cardboard sheets which were previously cut to a predetermined length and stacked with first liner sheets facing downwards. The corrugated cardboard sheets fed from the feeding unit through via transferring rolls are fed to a first sheet transfer unit.

More specifically, the corrugated cardboard sheets which were stacked after fabrication are inverted or turned upside down by an auto-feeder with an inverting mechanism (not shown), before being transferred to the feeding unit. The auto-feeder with an inverting mechanism comprises a horizontal plate and a vertical plate with an L-shaped cross section, a conveyer being provided on the vertical plate. The auto-feeder is rotated 90 degrees about an axis at the intersection of the horizontal and vertical plates so that the horizontal and vertical plates are swung respectively to their vertical and horizontal positions. Thus the stack of sheets on the horizontal plate is transferred to the feeding unit of the rotary printing press with the adjacent sheets partially overlying each other. This results in the corrugated cardboard sheets being transferred to the feeding unit with the second liner sheet (devoid of press marks) facing upwards.

The first sheet transfer unit comprises upper and lower conveyers between which corrugated cardboard sheets are sandwiched and transferred to the rotary printing unit described in greater detail below. The printed sheets are transferred to a creaser unit where the first liner sheet is creased and then to a slotter unit where the printed sheets are slotted or to a die-cutter unit where they are die-cut, so that the sheets may be stacked on one another after being folded.

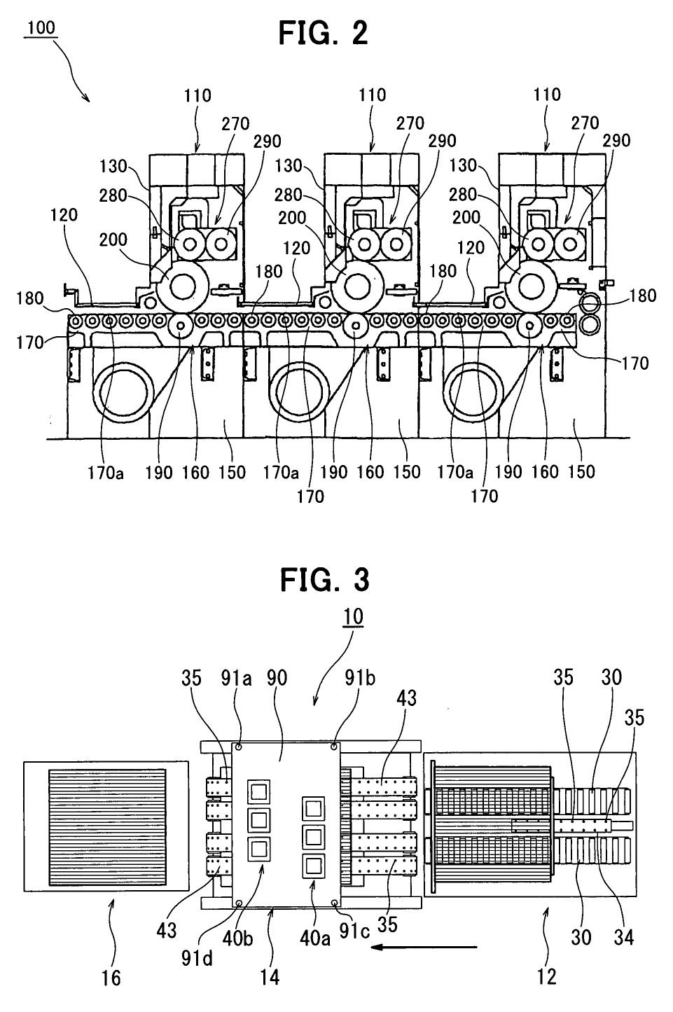

FIG. 2 shows an overall side view of the entire printing press. The printing press 100 is shown as a rotary press of the type comprising three printing units 110 arranged in series. The corrugated cardboard sheets are fed horizontally by the feeding unit (not shown) and are printed with desired colors in the respective rotary printing units. A small platform or step 120 is provided for facilitating the replacement of the printing die or plate and located between the adjacent printing units 110, so that a printing press operator can replace the printing plate by stepping on platform 120. Each printing unit 110 is enclosed inside a cover 130, and a door provided in the cover 130 at one side of the platform 120.

Each of the printing units 110 comprises a pair of frames 150, 150 spaced transversely from each other on opposite side of the feed path or pathway of the corrugated cardboard sheets. A sheet transfer system 160 is provided between the frames 150, 150 and below the pathway of the sheets. The sheet transfer system 160 includes an air box 170 disposed below the sheet pathway, as shown in FIG. 2. Suction means preferably comprises an exhaust fan or blower (not shown) connected to the air box 170 so that negative pressure is produced in the air box 170 through the operation of the suction means. A plurality of openings or orifices 170a are provided on an upper side of the air box 170.

A plurality of transfer members such as rotatably driven rolls 180 are provided inside the air box 170. Each of driven rolls 180 is positioned so that the outer peripheral surface thereof protrudes outwardly from the corresponding openings or orifices 170. More specifically, the sheets are transferred by the rotationally driven rolls 180 with the underside of the sheets bearing against the driven rollers 180 owing to the suction force applied by the negative pressure in the air box 170.

A pressure roll 190 defining supporting means during printing is also provided inside the air box 170 at the sheet transfer unit 160. The pressure roller 190 is positioned so that the outer peripheral surface thereof upwardly protrudes through the corresponding opening or orifice 170 in a similar fashion as driven rolls 180. The pressure rolls 190 are set at the same level as driven rolls 180 so that the sheet passes through the pressure roll position without changing its level.

A printing cylinder 200 with a printing die or plate (not shown) is removably mounted on the outer surface of the printing cylinder is provided between the frames 150, 150 and positioned facing pressure roll 190. The pressure roll 190 and the printing cylinder 200 are adapted to be rotated in the opposite directions. The printing cylinder 200 may be moved towards and away the pressure roll 190 by means of an eccentric displacement mechanism (not shown).

An ink transfer mechanism 270 for transferring ink to the printing die or plate is provided above the printing cylinder 200. The ink transfer mechanism transfers ink to the printing plate and includes a doctor roll 290 which applies ink to the ink transfer roller 280, and a swing mechanism (not shown) which swings about the rotation axis of the doctor roll 290 over a predetermined angular range. The doctor roll 290 is disposed adjacent the ink transfer roll 280 and maintains contact with the ink transfer roll 280 during printing, while at the same time ‘squeegees’ or wipes the excess ink from the surface of the ink transfer roller 280 by rotating at a rotational speed low than that of the ink transfer roll 280.

The operation of the printing units will now be described. First the printing cylinder 200 is placed in a printing position adjacent the pressure roll 190 which is fixed in position. The pressure roll 190 and the printing cylinder 200 are rotated in opposite directions while the ink transfer roll 280 is also rotated in the opposite direction to the printing cylinder 200. Doctor roll 290 is rotated in the direction opposite to that of the ink transfer roll 280 at a lower rotational speed than the ink transfer roll 280. This causes ink fed between the ink transfer roller 280 and the doctor roll 290 to be transferred to the printing plate mounted on the printing cylinder 200 via the ink transfer roll 280 while it is being squeezed or wiped. The corrugated cardboard sheets fed from the feeding unit to the printing units 100 one after another and between the printing cylinder 200 and the pressure roll 190 with the second liner sheet (devoid of press marks) facing upwards to be printed by the printing plate and the first liner sheet being supported by the sheet transfer system 160.

The corrugated cardboard sheets are fed by the contact pressure exerted between printing plate and the printing cylinder 200 while ink is transferred to the first liner sheet (having press marks) of the corrugated cardboard sheets, thereby printing the first liner sheet. Since the underlying second liners of the corrugated cardboard sheets are pressed down by the application of suction the printing is conducted without smearing.

After the first liner sheets have been printed, the corrugated cardboard sheets are stacked on top of each other. Paper dust produced during slotting or die-cutting the sheets may be removed from the surfaces by dust removing means (not shown) disposed at a discharge end of the printing unit or the stacker. The first liners of the entire lot of corrugated cardboard sheets are thus printed with the ‘constant’ or preset print image and the rotary printing press operates are at a high throughput and high efficiency as the sheets are transferred at high speed without any negative influence from the subsequent stage printing of the sheets.

The second printing stage or operation which is an ink jet printing stage or operation will now be described.

As shown in FIG. 1, the second printing stage or operation comprises a feeding step, a printing step for printing the first liner (having press marks) of the corrugated cardboard sheet, and then stacking the printed sheets.

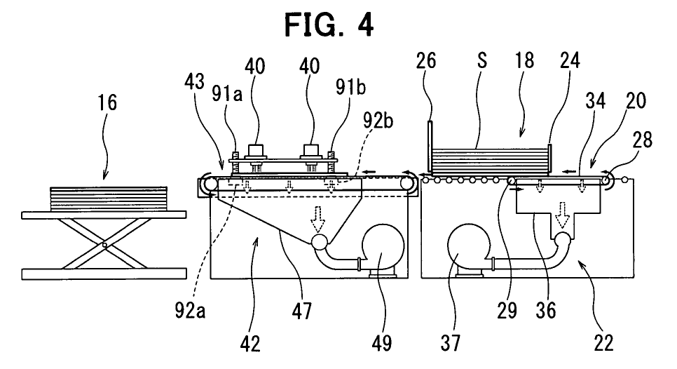

As can be seen in FIGS. 3 and 4, the second stage printing machine 10 comprises a feeding unit 12, a printing unit 14 and a stacking unit 16, and these units are aligned with respect to each other, as shown by an arrow.

The feeding unit 12 feeds cardboard sheets which are produced in an upstream step to the printing unit 14 which includes a hopper 18 for stacking the sheets, a conveyor 20 for transferring the sheets to the printing unit 14, and a suction device 22 for applying suction to the sheets to force or suck them against the conveyor 20. The hopper 18 includes an upstream back stop 24 and a downstream front stop 26 movable upwardly and downwardly, so as to stack each sheet therebetween. A gap is provided at the bottom of the front stop 26, the gap being larger than the thickness of one sheet and smaller than the thickness of two stacked sheets. According to such an arrangement described above, stacked sheets can be transferred one at a time to the printing unit 14 via conveyor 20. The conveyor 20 has a pair of rollers, namely a driving roller 28 and an idle roller 29 and an endless belt 34 disposed between and run around the pair of rollers. The conveyor 20 is located between rows of idle rollers 30 respective sides thereof, and the sheet is conveyed by the belt 34 to the printing unit 14. The belt 34 has a plurality of suction holes or apertures 35 so when a sheet is carried by the belt 34, it covers suction holes 35 and is forced or sucked against the belt 34 by means of the suction device 22, thereby preventing shifting of the sheet relative to the belt 34. As described, the suction device 22 is located below the belt 34 and includes a suction box 36 extending in the feeding direction and an exhaust fan 37 for sucking or exhausting air out of the suction box to produce negative pressure.

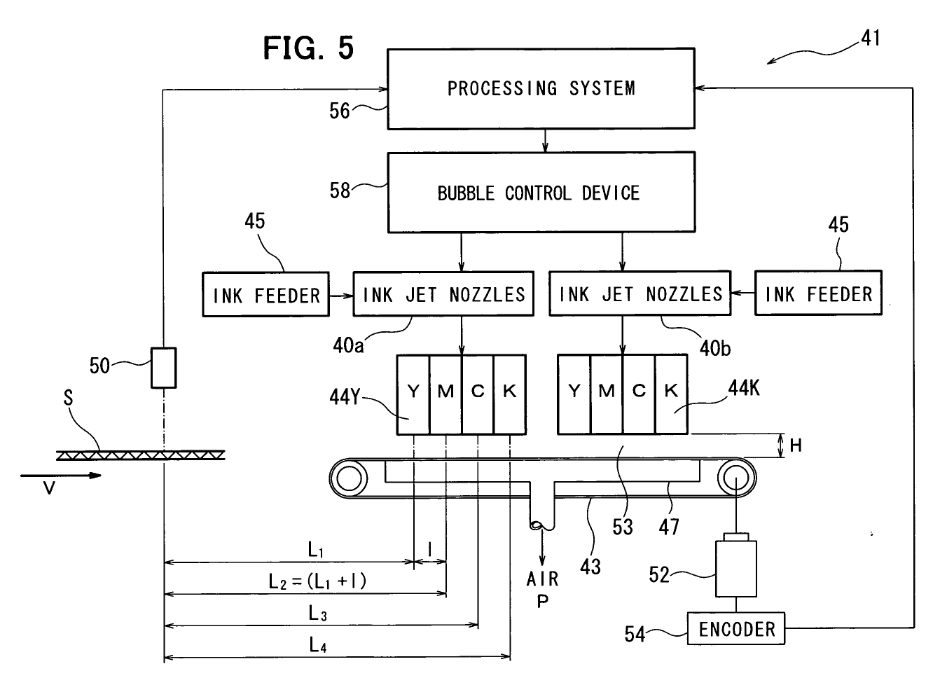

Ink jet printing unit 14 includes ink jet heads 40 located above the level of the sheet, an ink-jet control device (see FIG. 5), a suction device 42 located below the level of the sheet, and a conveyor 43 of a similar construction to that of the feeding unit 12. The ink jet heads 40 include two sets of heads, i.e. a first set of ink jet heads 40a and a second set of ink jet heads 40b. Each of the ink jet heads includes a plurality of ink jet nozzles 44. The ink jet heads of the first and second sets of ink jet heads 40a, 40b are aligned with each other transversely to the feed so as to cover the entire transverse dimension of the sheet. The number of heads 40 will depends on the size of the sheet, however, in the illustrated embodiment, the first and second sets of the ink jet heads 40a and 40b each have three heads, for a total of six heads.

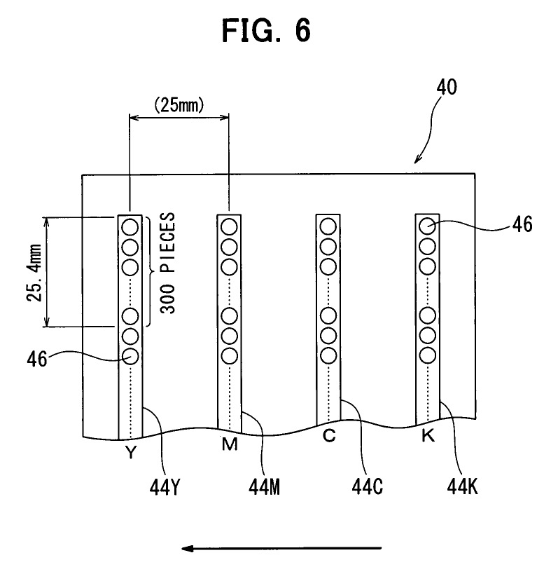

As can be seen in FIG. 6, each of the ink jet heads 40 has four groups of ink jet nozzles 44Y, 44M, 44C and 44K which respectively correspond to the colors yellow (Y), magenta (M), cyan (C) and black (K). Each group includes a plurality of spaced apart ink jet nozzles, for example, 84 microns from each other in the transverse direction, and comprises four units each having three hundred such nozzles. These four groups of nozzles 44Y, 44M, 44C and 44K are located downstream to upstream in the order of YMCK and are spaced 25 mm from each other in the feed direction. With such an arrangement of the ink jet nozzles 44, a printing image having a 300 dpi (dots per inch) resolution is obtained.

More specifically, the arrangement of dots in the transverse direction determined by the ink droplets jetted out or ejected from the same ink jet nozzles closely corresponds to the arrangement of the ink jet nozzles in the transverse direction. In other words, the pitch or space between adjacent dots on the sheet is determined by gaps or spaces in the transverse direction between the adjacent ink jet nozzles. In the described embodiment the 300 dpi resolution in the transverse direction results from the above-described arrangement of the ink jet nozzles. By contrast, the arrangement of dots in the sheet feeding direction is determined by sum of the time period for travel of ink droplets to travel between the ink jet nozzle and the surface of the sheet and time period for a bubble to be generated in the ink jet nozzle times the velocity of the sheet being conveyed. The droplet travel time and the bubble formation time period totally depend on the thermal type ink jet printing technique employed.

To obtain a homogenous print finish, the dpi in the transverse direction is normally set to be the same as to that in the feed direction. Accordingly, the feed velocity may be determined so that the dpi in the feed direction matches that in the transverse direction which in turn is determined by the transverse spacing arrangement of the ink jet nozzles. For ink jet printing of cardboard sheets, the dpi resolution may be between about 300 dpi to about 900 dpi to so as to obtain a print image of suitable definition and satisfactory ink jet printing production.

The ink jet heads 40a, 40b and the ink jet nozzles 44 of the ink jet heads 40 may span the entire transverse extent of the sheet to be printed and are controlled by the ink-jet control device 41 to create printing image by YMCK dots formed on the surface.

Each ink jet nozzle 44 is caused to eject ink supplied by respective ink reservoirs 45 (see FIG. 5) to impinge on the surface S of the sheet. To this end, an electrical potential is applied at the bottom of the ink jet nozzles 44 to form heated bubbles in the ink jet nozzles and to cause the ink droplets to be emitted from the tips thereof. The volume of each ink droplet is, for example, about 150 pico-liter and the electrical potential is adjusted so as to eject ink droplets of such a volume at a constant speed.

The construction of the suction device 42 and the transfer conveyor 43 is similar to suction device and transfer conveyor for the feeding unit 12, as can be seen in FIGS. 3 and 4. The suction device 42 includes a suction box 47 and an exhaust fan 49 disposed below the upper run of conveyor 43. Conveyor 43 includes four rows of conveyors belts spaced apart from each other in the transverse direction. Suction holes or apertures 35 in the conveyor belts apply a suction force to the sheet being conveyed toward the printing unit 14. Also, air will be drawn by the suction device 42 from the space 53 between the ink jet heads and the surface S of the sheet being transported and then from the upper side of the sheet to the lower side of the sheet through the holes 35 in the conveyor belts. This can affect the ink droplet trajectories from the ink jet nozzles 44 toward the surface of the sheet. The suction pressure applied is preferably from 1 kPa to 5 kPa.

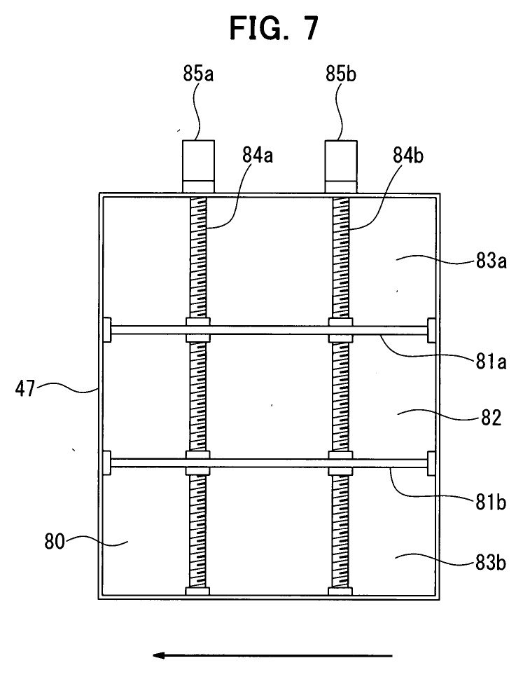

The transverse dimension of the suction box 47 is large enough to be in registration with all suction holes 35 and is longer than any sheet and has a rectangular opening facing the upper run conveyor 43. As shown in FIG. 7, the suction box 47 has a pair of partitions 81a, 81b extending in the feeding direction of the sheet, as represented by an arrow to form a central suction area 82 and adjacent non-suction areas 83a and 83b. The pair of partitions 81a, 81b are supported by a pair of threaded rods 84a and 84b adapted to be rotated by partition adjusting motors 85a and 85b to move the partitions 81a, 81b in the transverse direction and thereby adjust the transverse dimension of the suction area 82 in correspondence to the transverse dimension of the sheet.

As shown in FIG. 5, the ink-jet control device includes a sheet position sensor 50, an encoder 54 mounted on a conveyor drive shaft 52, a processor 56 which receives signals from the sheet position sensor 50 and the encoder 54, and a bubble control device 58 which receives signals from the processor 56 and transmits signals to the ink jet nozzles.

The operation of the ink jet printing machine 10 will now be described.

First, similar to the turning over of the corrugated cardboard sheets after the manufacturing step and before the first printing operation in the rotary press, the stack of the corrugated cardboard sheets after the first printing operation is turned over by an auto-feeder with an inverting or turnover mechanism (not shown) so that first liner (having press marks) faces upwards, and is transferred to the feeding unit 12.

The orientation of the corrugations or flutes of the corrugated cardboard sheets is selected as desired so that the corrugations of the individual sheets extend either in the feed direction or in a direction perpendicular to the feed direction. When the corrugations or flutes extend transversely to the feed direction, the distance between the tips of each of the ink jet nozzles and the surface of the first liner varies as the sheet is displaced, since the crests and troughs of the corrugations alternately pass below the ink jet nozzles, whereas when the corrugations or flutes extend in the feed direction the distance between the tips of the nozzles and the surface of the first liner remains constant. The following description is for the case where the corrugations or flutes extend perpendicular to the feed direction.

Then, the motor 85 adjusts the position of the partitions 81a, 81b to coincide with the transverse dimension of the sheets and thus the transverse dimension of the suction area 82 is adjusted to entire transverse dimension of the sheet to be conveyed and printed.

Also, data relative to feed distances L1, L2, L3 and L4 that is this distances from the sheet position sensor 50 to the respective ink jet heads 40 and data relative to sheet feeding speed V are stored in the processor 56. When the sheets are fed one at a time from the feeding unit 12 to the printing unit 14, the lower surface of the sheet, that is the second liner, is applied flat against the conveyor belts by means of the suction device 22 to eliminate any warping of the sheet, and then the sheet passes just beneath the ink jet heads 40 without any shifting of the sheet relative to the conveyor belts. When the sheet passes beyond the sheet position sensor 50, a detection signal is transmitted to the processor 56. When the sheet position sensor 50 detects the front end of the sheet which is being displaced, the detection signal is transmitted to the processor 56. At the same time, the encoder 54 starts counting the rotations of the motor 42, and a rotation count signal is transmitted to the processor 56. The processor 56 converts the rotation count signal to distance data using the sheet feeding speed data, and when the converted distance data matches the predetermined data, the processor transmits a signal to the bubble control device 58. The bubble control device 58 transmits a control signal to the ink jet heads 40 to cause ink to be ejected from the nozzles 44 toward the surface S of the first liner of the sheet and ink droplets to land on the surface S of the first line to form a predetermined array of dots on the surface S, resulting in the printing of the desired image with the desired colors and shape by means of the YMCK color dots.

More specifically, each of the ink droplets having a given volume is ejected from the tip of each of the ink jet nozzles 44 toward the surface S of the first liner by applying an electric potential of the thermal type in order to form a bubble of a corresponding volume.

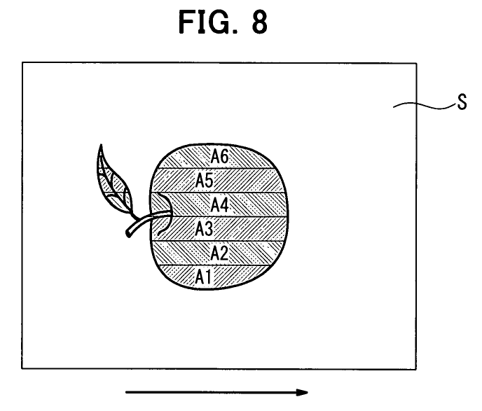

The ink jet printing operation as just described is carried out for the first set of ink jet heads 40a and the second set of ink jet heads 40b. More particularly, the printing areas A2, A4 and A6 are printed by means of the first set of ink jet heads 40a, and thereafter the printing areas A1, A3 and A5 are printed by means of the second set of ink jet heads 40b. FIG. 8 shows an example of a printed image.

Then, the printed sheet is fed to the stacking unit 16 where it is stacked. This completes the second printing stage of the corrugated cardboard sheets.

Similarly when the corrugated cardboard product is a single-faced corrugated cardboard sheet the linear pressed marks spaced from each other by a distance corresponding to a pitch or distance between the crests of the corrugated cardboard sheet are inevitably generated on the surface of the first liner due to the gluing of that liner to the corrugated core sheet, it is possible to print the surface of the first liner by the ink jet printing so that the press marks do not become more conspicuous through printing. More specifically, with ink jet printing, unlike rotary press printing, it is possible to apply ink without contact and the application pressure in the nips of the pressure and printing rolls of the respective print units, to produce a desired printing image on the first liner by ejecting ink droplets to form vast number dots on the surface even for the multiple-color printing.

Regardless of the type of corrugated cardboard sheet printed, it is then assembled into the corrugated cardboard product, by folding along the crease lines with one of the surfaces, e.g., the first liner (with press marks) defining an interior surface of the product while the second liner (devoid of press marks) defines the exterior surface, thereby completing the corrugated cardboard product.

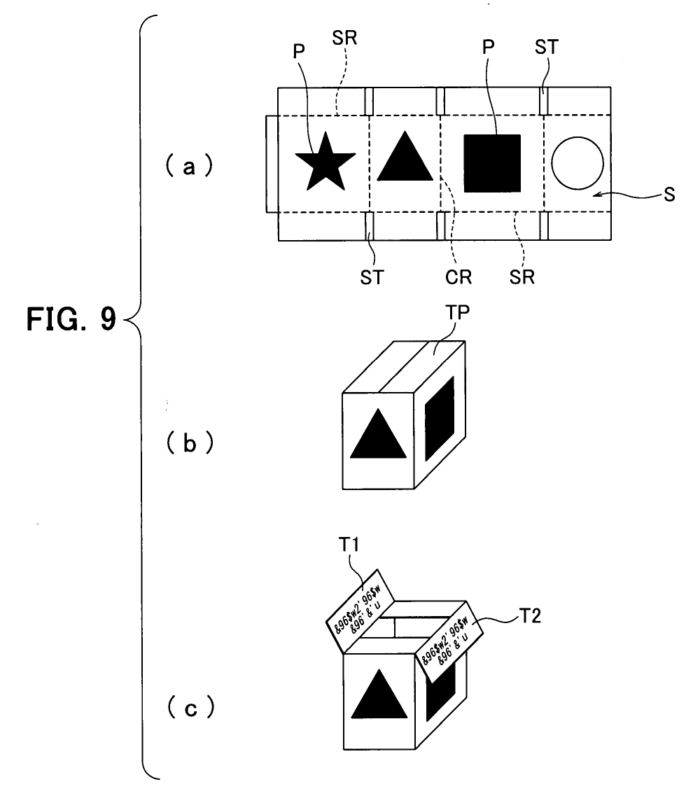

FIG. 9 shows the gift box made from the corrugated cardboard sheet. FIG. 9(a) shows a developed or laid-out sheet showing second liner of the sheet after it is printed. FIG. 9(b) shows the assembled cardboard sheet product at the completion of the assembly step. FIG. 9(c) shows the assembled product with the two cover flaps open to show the printed undersides of the cover flaps of the gift box. In FIG. 9, reference P, SR, ST, CR, T1 and T2 respectively designate the printed images, longitudinal creases or scores, slots, transverse creases or scores, and the undersides of the cover flaps.

As stated above, the second stage printing can be conducted on demand without compromising the printing efficiency as the constant or preset printed image is carried out in advance by rotary press printing, while custom or small run printed images are produced subsequently in the ink jet printing step.

Even though the ink jet printing may not at present be superior to the rotary press printing in terms of the printing efficiency, that is throughput, various kinds of printed images for small volumes may be printed without compromising the overall printing efficiency since the large volume lots with a constant or preset printed image are printed in advance on the second liner surface of the corrugated cardboard product in the rotary press while custom or small run images are printed on demand by ink jet printing off-line relative to the rotary press printing.

Second, the printing of the constant or preset printed image is conducted in advance in high efficiency or throughput rotary press and sheets may be creased and slotted or die-cut in the same pass-line, e.g. after printing, and then stacked and at the same time paper dust produced and deposited on the surfaces of the sheets during these operations is removed.

Alternatively, unlike the previously described embodiment, not only the second liner surface (devoid of press marks) of double-faced corrugated cardboard sheets, but also the first liner surface (with press marks), which constitutes an interior surface when the sheet is assembled into the corrugated cardboard product, may be printed during the first, rotary press printing step.

More specifically, the interior surface of a gift box, with a message such as congratulations on a birthday can be printed in advance in the first, rotary press printing step, while a name, a picture, or a photograph of a person to be congratulated may be printed on demand in the second ink jet printing step. In such a case, the first liner surface with press marks is printed by rotary press printing, but the press marks are not particularly conspicuous since the printing area is limited to the underside of the cover of the gift box.

In order to realize such a printing operation, in the first rotary press printing step, the second liner surface (devoid of press marks) faces upwards, a first group of the printing units for printing the second liner surface and a second group of the printing units for printing the first liner surface may be arranged in series along the same pass-line, whereby each printing unit of the second group, including the printing cylinder 200 with the printing plate and the pressure roller 190 are disposed on upper and lower sides of the sheet, respectively, or vice versa.

In still another alternative embodiment, in a case where the size of the print lots is small, and there are many kinds of possible printed images, there is no need for printing a constant or preset print image in advance, not only is the first liner surface (with press marks) but also the second liner surface (devoid of press marks) can be printed on demand by two step ink jet printing carried out along the same pass-line.

In such a case, by arranging the ink jet heads 40 as shown in FIG. 4 on the upper and lower sides of the sheet along the same pass-line upper and lower surfaces of the sheet can be alternately printed along the same pass-line. For this purpose, suitable suction means are disposed opposite the printing heads on the respective sides of the sheet to ensure that the sheet does not buckle or shift during printing on either side.

According to the above configuration, even when carrying out multiple-color printing on both surfaces of a corrugated cardboard sheet, it is possible to print them along the same pass-line without causing deviations of the printing positions. After the corrugated cardboard sheet has been ink jet printed on both sides, it is then creased or scored and slotted, or die-cut. As stated above, the ink jet printing can be effectively carried out in such a case because the negative effect of the suction on ink jet droplet trajectories through the slots or around the edges of the cutout sheet by the suction air can be avoided as the creasing or scoring and slotting, or the die-cutting of the sheet is preferably carried out after the ink jet printing.

In short, with respect to various kinds of corrugated cardboard products for which small volumes are required, the predetermined printed image required on say the outer surface of the product can be printed, and wide range of printed images on say the inner surface thereof can be printed, and ink jet printing allows a great variety of printing images to be produced quickly on demand which is not possible with rotary press printing.

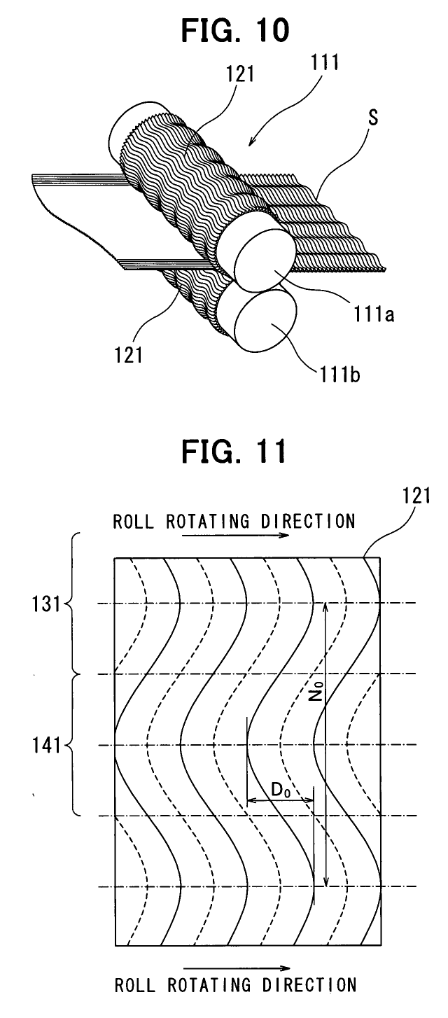

A second embodiment is now described in detail with reference to FIGS. 10 to 13.

In this embodiment, single-faced corrugated cardboard sheets comprising a core sheet and a first liner sheet are used. The core sheet preferably has a special patterned corrugation design which as illustrated comprises wavy or undulating patterned flutes or corrugation. Such single-faced corrugated cardboard sheets can be printed, processed, and assembled according to the present invention.

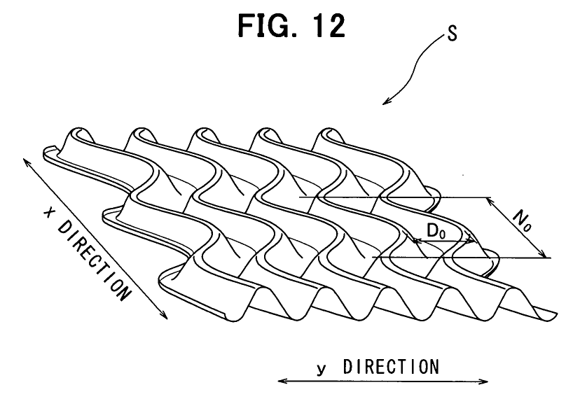

As can be seen in FIG. 10, an apparatus for manufacturing the wavy patterned corrugated sheet includes a pair of rollers, namely an upper roller 110a and a lower roller 110b in place of the pair of rollers shown in FIG. 14. When a flat sheet is fed between such rollers under a predetermined nip pressure, a sheet is produced having wavy patterned corrugations or flutes extending in a transverse direction (X) as well as a feeding or longitudinal direction (Y) direction, as shown in FIG. 12. The degree of the waviness, that is, the transverse direction (X), is typically indicated by D₀/N₀ in FIG. 11.

More particularly, each of the corrugating rollers has a plurality of corrugating teeth 120 on the outer surface thereof. FIG. 11 shows a developed or laid-out plan view of the corrugating teeth 120. As can be seen in FIG. 11, the corrugating teeth 120 include front corrugating teeth 130 for forming a front wave portion located upstream with respect to the rotation of the roller 110, and rear corrugating teeth 140 for forming a rear wave portion located downstream thereof. The average depth of the interpenetration between the rollers in the rear teeth 140 is set to be larger than that of the front teeth 130. By such an arrangement, excessive wrinkling or deformation of the sheet during corrugation can be prevented, and the resulting sheet has a high uniform strength, and the wavy patterned corrugations are properly formed, without any problems, such as tearing of the sheet.

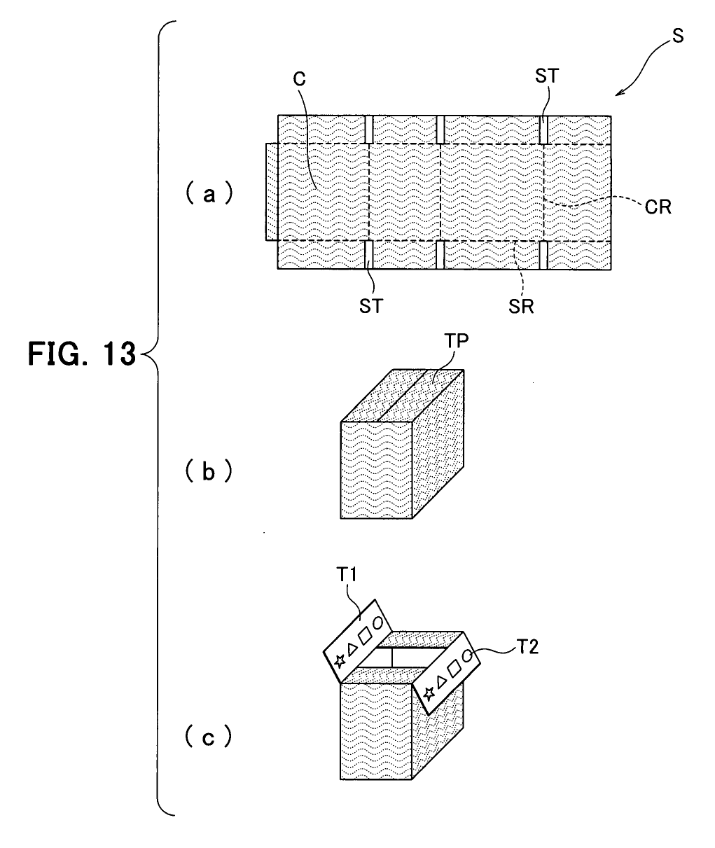

Now, the differences between the first and second embodiments are now explained. FIG. 13 which is similar to FIG. 9 shows the gift box made from the single-faced corrugated cardboard sheet. FIG. 13(a) shows a developed sheet after the first liner surface of the sheet is printed, FIG. 13(b) shows the assembled sheet after an assembly step, and FIG. 13(c) shows the printed first liner sheet defining an underside of the cover of a gift box

The manufacture of the wavy patterned corrugated cardboard sheets is essentially the same as the manufacture of any single-faced corrugated cardboard sheets as described in connection with the first embodiment except for a pair of corrugating rollers 400 being used. The application of the second liner sheet in a double-facer is obviously not required. But the scoring or creasing steps and/or slotting steps, or the die-cutting step, and the stacking steps are the same as in the first embodiment. One of the surfaces of the stacked corrugated cardboard sheets comprises a liner surface with press marks while the surface comprises wavy patterned corrugated surface.

In this embodiment, there is no rotary press printing step. Also since the liner has print marks, it is preferable to print the (first) liner surface by ink jet printing. The corrugated surface is not printed. The sheet may be scored or creased and/or slotted or die-cut, folded, and stacked as shown in FIG. 13(a).

The ink jet print stage in the second embodiment is similar to that of the first embodiment. The (first) liner surface of the sheets with the press marks is printed in a non-contact manner, and then the printed sheets are stacked.

The assembly of the corrugated cardboard product of the second embodiment is similar to that of the first embodiment. The corrugated cardboard product is folded and assembled with the wavy patterned corrugated surface defining the exterior surface of the product while the printed liner surface defines the interior surface of the product.

As shown in FIG. 13(b), the wavy patterned corrugated surface defines the exterior surface of the completed gift box giving the box a unique and distinctive appearance with the conspicuous wave patterned corrugated outside surface. In addition, as shown in FIG. 13(c), when the cover is opened, the printed image on the interior surface produced during ink jet printing step provides an attractive surprise for the recipient when the box is opened.

As noted above, in the conventional doubled-faced corrugated cardboard is structurally necessary for making boxes for carrying relatively heavy contents. Single-faced corrugated cardboard sheets have not been used for shipping boxes for this reason. The novelty application for a gift box intended to carry lightweight items does not require the higher strength of doubled-faced corrugated cardboard and provides a striking and novel aesthetic appearance thanks to the corrugated surface being made visible and attractive.

While the methods disclosed herein have been described and shown with reference to particular steps performed in a particular order, it will be understood that these steps may be combined, sub-divided, or reordered to from an equivalent method without departing from the teachings of the present invention. Accordingly, unless specifically indicated herein, the order and grouping of steps is not a limitation of the present invention.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A method for manufacturing a printed corrugated cardboard product, the method comprising:
preparing a corrugated cardboard sheet including a corrugated core sheet and at least a first liner sheet;
securing crests of the corrugated core sheet to the first liner, the first liner having visible press marks; and
ink jet printing an image on the first liner.

2. The method according to claim 1, wherein the corrugated cardboard sheet is a single-faced corrugated sheet, the opposed sides of the corrugated sheet being defined by the corrugated core sheet and the first liner, respectively.

3. The method according to claim 2, further comprising the step of folding and assembling the single-faced corrugated sheet into a box or box component with the corrugated core sheet defining the exterior surface of the box or box component, and the first liner sheet defining the interior of the box or box component.

4. The method according to claim 3, further comprising forming wavy patterned corrugations the core sheet.

5. The method according to claim 1, wherein the corrugated cardboard sheet is a double-faced or multi-layered corrugated cardboard sheet and has a second liner secured to crests of a corrugated core sheet opposite the first liner, the second liner sheet being substantially devoid of press marks at zones of contact between the crests of the core sheet and the second liner.

6. The method according to claim 5, further comprising the step of ink jet printing an image on the second liner.

7. The method according to claim 5, wherein the first and the second liners are ink jet printed.

8. The method according to claim 5, wherein the first and the second liners are rotary press printed.

9. The method according to claim 5, wherein the first liner and the second liner are ink jet printed in a single run by ink jet heads disposed on opposite sides of a path of displacement of the corrugated cardboard sheet.

10. The method according to claim 9, wherein the second liner of a plurality of corrugated cardboard sheets is rotary press printed with a first printing image and the rotary press printed corrugated cardboard sheets are subsequently ink jet printed in smaller lots and a second printing image for at least one of the smaller lots being different from a second printing image for another of the smaller lots.

11. The method according to claim 5, further comprising the step of printing an image on the second liner sheet in a rotary press.

12. The method according to claim 11, wherein the rotary press printing step is followed by at least one of creasing or scoring, or slotting or die-cutting the printed corrugated cardboard sheets before removing paper dust from the corrugated cardboard sheets and before stacking the corrugated cardboard sheets for subsequent ink jet printing of the first liner.

13. The method according to claim 11, further comprising the step of folding and assembling the corrugated cardboard sheet so that the first liner defines an interior surface of a box or box component and the second liner defines an exterior surface of a box or box component.

14. The method according to claim 11, further comprising the step of folding and assembling the corrugated cardboard sheet so that the second liner defines an interior surface of a box or box component and the first liner defines an exterior surface of a box or box component.

15. The method according to claim 1, wherein the image is at least one of graphics, pictures, codes, or text.

16. The method according claim 1, wherein the corrugations of the core liner are glued to the first liner with the application of pressure in excess of 30 kg/cm2 such that the glue penetrates into the core liner, and ink jet printing is carried out so as to avoid contact between glue and the ink.
